(19) United States
(12) Patent Application Publication
(10) Pub. No.: US 2016/0093273 A1
(43) Pub. Date: Mar. 31, 2016

(54) DYNAMIC VISION SENSOR WITH SHARED PIXELS AND TIME DIVISION MULTIPLEXING FOR HIGHER SPATIAL RESOLUTION AND BETTER LINEAR SEPARABLE DATA

(71) Applicant: Samsung Electronics Co., Ltd., Suwon-si (KR)

(72) Inventors: Yibing M. WANG, Temple City, CA (US); Zhengping JI, Pasadena, CA (US); Ilia OVSIANNIKOV, Studio City, CA (US)

(21) Appl. No.: 14/550,899

(22) Filed: Nov. 21, 2014

Related U.S. Application Data
(60) Provisional application No. 62/058,085, filed on Sep. 30, 2014.

(51) Int. Cl. G09G 5/391

(52) U.S. Cl. CPC G09G 5/391

(57) ABSTRACT

A Dynamic Vision Sensor (DVS) where pixel pitch is reduced to increase spatial resolution. The DVS includes shared pixels that employ Time Division Multiplexing (TDM) for higher spatial resolution and better linear separation of pixel data. The pixel array in the DVS may consist of multiple N×N pixel clusters. The N×N pixels in each cluster share the same differentiator and the same comparator using TDM. The pixel pitch is reduced (and, hence, the spatial resolution is improved) by implementing multiple adjacent photodiodes/photoreceptors that share the same differentiator and comparator units using TDM. In the DVS, only one quarter of the whole pixel array may be in use at the same time. A global reset may be done periodically to switch from one quarter of pixels to the other for detection. Because of higher spatial resolution, applications such as gesture recognition or user recognition based on DVS output entail improved performance.

### CROSS-REFERENCE TO RELATED APPLICATIONS

This application claims the priority benefit under 35 U.S.C. §119(e) of U.S. Provisional Application No. 62/058,085 filed on Sep. 30, 2014, the disclosure of which is incorporated herein by reference in its entirety.

### TECHNICAL FIELD

The present disclosure generally relates to vision sensors. More particularly, and not by way of limitation, particular embodiments of the inventive aspects disclosed in the present disclosure are directed to a Dynamic Vision Sensor (DVS) consisting of multiple clusters of pixels, wherein each cluster of pixels shares a common differentiator unit and a common comparator unit among multiple photoreceptors using time division multiplexing.

### SUMMARY

Current DVS designs provide fast and accurate sensing, efficient encoding of local changes in scene reflectance, low resolution bits for pixels (and, hence, less power consumption), wide dynamic range (e.g., large illumination range on the order of 120 dB), precise timing information for Address Events, good temporal resolution of less than 10 μs, and low post-processing overhead. Despite these advantages, current DVS designs suffer from lower spatial resolution. On the other hand, applications such as gesture recognition or user recognition based on DVS output have higher performance when a DVS's spatial resolution is higher.

Hence, it is desirable to increase spatial resolution of a DVS sensor. It is further desirable to improve recognition performance of a DVS sensor.

In particular embodiments of the present disclosure, pixel pitch is reduced to increase spatial resolution. Because each pixel has many transistors whose size may be hard to reduce, the inventive aspects of one embodiment of the present disclosure provide for a DVS with shared pixels that employ Time Division Multiplexing (TDM) for higher spatial resolution. In one embodiment, the pixel array in the DVS may consist of multiple 2×2 pixel clusters. The 2×2 pixels in each cluster share the same differentiator and the same comparator using TDM. In other words, a portion of each pixel is shared by other pixels in a pixel cluster. Hence, the DVS according to the teachings of the present disclosure effectively consists of “shared pixels.” In particular embodiments, the pixel pitch is reduced (and, hence, the total number of pixels or spatial resolution is improved) by implementing multiple adjacent photodiodes/photoreceptors that share the same differentiator and comparator units in a time division multiplexed fashion.

In a DVS according to one embodiment of the present disclosure, only one quarter of the whole pixel array is in use at the same time. A global reset may be done periodically to switch from one quarter of pixels to the other for detection. In one embodiment, the time division multiplexing not only enables higher spatial resolution, but also reduces Address Event Representation (AER) bandwidth and provides better linear separation of data to improve recognition performance of the DVS sensor.

In one embodiment, the present disclosure is directed to a vision sensor that comprises a plurality of N×N pixel clusters; and a digital control module coupled to the plurality of N×N pixel clusters. Each pixel cluster in the N×N pixel clusters includes the following: (i) N×N photoreceptors, wherein each photoreceptor converts received luminance into a corresponding electrical signal; (ii) a cluster-specific differentiator unit coupled to and shared by all of the N×N photoreceptors, wherein, for each photoreceptor in the N×N photoreceptors, the differentiator unit receives the corresponding electrical signal from the photoreceptor and generates a photoreceptor-specific difference signal indicative of the deviation of the corresponding electrical signal from a differentiator unit-specific reset level; and (iii) a cluster-specific comparator unit coupled to the differentiator unit and shared by all of the N×N photoreceptors, wherein, for each photoreceptor in the N×N photoreceptors, the comparator unit receives the photoreceptor-specific difference signal and generates a corresponding pixel event signal indicative of a change in contrast of the received luminance. The digital control module provides for sequentiation and read-out of pixel event signals from each cluster-specific comparator unit. In one embodiment, N=2.

In another embodiment, the present disclosure is directed to an N×N pixel cluster, which comprises: (i) N×N photoreceptors, wherein each photoreceptor is configured to convert received luminance into a corresponding electrical signal; (ii) a single differentiator unit configured to be coupled to and shared by all of the N×N photoreceptors, wherein, for each photoreceptor in the N×N photoreceptors, the differentiator unit is configured to receive the corresponding electrical signal from the photoreceptor and generate a photoreceptor-specific difference signal indicative of the deviation of the corresponding electrical signal from a differentiator unit-specific reset level; and (iii) a single comparator unit coupled to the differentiator unit and configured to be shared by all of the N×N photoreceptors, wherein, for each photoreceptor in the N×N photoreceptors, the comparator unit is configured to receive the photoreceptor-specific difference signal and generate a corresponding pixel event signal indicative of a change in contrast of the received luminance.

In a further embodiment, the present disclosure is directed to a system that comprises a DVS; a memory; and a processor coupled to the DVS and the memory. In the system, the DVS includes a plurality of 2×2 pixel clusters, wherein each pixel cluster includes: (i) 2×2 photoreceptors, wherein each photoreceptor converts received luminance into a corresponding electrical signal; (ii) a cluster-specific differentiator unit coupled to and shared by all of the 2×2 photoreceptors, wherein, for each photoreceptor in the 2×2 photoreceptors, the differentiator unit receives the corresponding electrical signal from the photoreceptor and generates a photoreceptor-specific difference signal indicative of the deviation of the corresponding electrical signal from a differentiator unit-specific reset level; and (iii) a cluster-specific comparator unit coupled to the differentiator unit and shared by all of the 2×2 photoreceptors, wherein, for each photoreceptor in the 2×2 photoreceptors, the comparator unit receives the photoreceptor-specific difference signal and generates a corresponding pixel event signal indicative of a change in contrast of the received luminance. In the system, the memory stores program instructions and the processor is configured to execute the program instructions, whereby the processor is operative to receive and process pixel event signals from each cluster-specific comparator unit.

In yet another embodiment, the present disclosure is directed to a method of detecting motion in a scene. The method comprises: (i) using a Dynamic Vision Sensor (DVS) having a pixel array, wherein the pixel array consists of a plurality of 2×2 pixel clusters, and wherein each pixel cluster in the DVS includes 2×2 photoreceptors all of which share a cluster-specific differentiator unit and a cluster-specific comparator unit using time division multiplexing; (ii) for each pixel cluster, sequentially connecting the cluster-specific differentiator unit and the cluster-specific comparator unit to a different photoreceptor in the 2×2 photoreceptors to thereby collect a photoreceptor-specific pixel event signal from each photoreceptor in the pixel cluster, wherein the photoreceptor-specific pixel event signal is indicative of a change in contrast of luminance received from the scene at a respective photoreceptor; (iii) linearly separating scene-related data associated with each discrete quarter of pixels in the pixel array, wherein the scene-related data is based on the collection of all photoreceptor-specific pixel event signals from each pixel cluster in the pixel array; and (iv) detecting the motion in the scene based on a comparison of the scene-related data associated with one quarter of pixels in the pixel array with the scene-related data associated with each of the other quarters of pixels in the pixel array.

Thus, particular embodiments of the present disclosure provide for a DVS that implements pixel-sharing using TDM to increase spatial resolution and obtain better linear separable data. Because of higher spatial resolution, applications such as gesture recognition or user recognition based on DVS output entail improved performance.

### BRIEF DESCRIPTION OF THE DRAWINGS

In the following section, the inventive aspects of the present disclosure will be described with reference to exemplary embodiments illustrated in the figures, in which:

FIG. 1 shows a conventional DVS having an 8×8 pixel array;

FIG. 2 depicts the pixel circuit of each pixel in the pixel array of FIG. 1;

FIG. 3 illustrates a block diagram of an exemplary DVS according to one embodiment of the present disclosure;

FIG. 4 is an exemplary architectural layout of a 2×2 pixel cluster in the DVS of FIG. 3 according to one embodiment of the present disclosure;

FIGS. 5A and 5B illustrate two exemplary pixel switching patterns for the pixel array in FIG. 3 according to particular embodiments of the present disclosure;

FIGS. 6A-6C are exemplary gesture recognition plots comparing the resolution of the output of a 2×2 pixel-sharing scheme according to the teachings of particular embodiments of the present disclosure against the resolutions of two other types of outputs;

FIG. 7 shows results of an exemplary simulation of event data counts for a full resolution based pixel output scheme and a 2×2 shared pixel scheme according to one embodiment of the present disclosure;

FIG. 8 is an exemplary simulation plot showing graphs comparing the number of events lost in case of a TDM-based 2×2 pixel sharing scheme according to the teachings of the present disclosure and in case of low resolution sub-sampling of pixels;

FIG. 9 shows an exemplary flowchart for a method of detecting motion in a scene according to one embodiment of the present disclosure;

FIG. 10 depicts an exemplary plot to illustrate a soft margin-based Support Vector Machine (SVM) model for linear classification of data;

FIGS. 11A-11D illustrate performance simulation plots showing the effect of different values of the tradeoff parameter C on data separation for three types of DVS resolution schemes; and

FIG. 12 depicts an exemplary system or apparatus that includes the DVS of FIG. 3 according to one embodiment of the present disclosure.

### DETAILED DESCRIPTION

In the following detailed description, numerous specific details are set forth in order to provide a thorough understanding of the disclosure. However, it will be understood by those skilled in the art that the disclosed inventive aspects may be practiced without these specific details. In other instances, well-known methods, procedures, components and circuits have not been described in detail so as not to obscure the present disclosure. Additionally, it should be understood that although the disclosure is described primarily in the context of a DVS having an 8×8 pixel array, the described inventive aspects can be implemented in DVSs of other sizes as well.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” or “according to one embodiment” (or other phrases having similar import) in various places throughout this specification are not necessarily all referring to the same embodiment. Furthermore, the particular features, structures, or characteristics may be combined in any suitable manner in one or more embodiments. Also, depending on the context of discussion herein, a singular term may include its plural forms and a plural term may include its singular form. Similarly, a hyphenated term (e.g., “pre-determined”, “cluster-specific,” etc.) may be occasionally interchangeably used with its non-hyphenated version (e.g., “predetermined”, “cluster specific,” etc.), and a capitalized entry (e.g., “Time Division Multiplexing,” “Dynamic Vision Sensor”, etc.) may be interchangeably used with its non-capitalized version (e.g., “time division multiplexing,” “dynamic vision sensor,” etc.). Such occasional interchangeable uses shall not be considered inconsistent with each other.

It is noted at the outset that the terms “coupled,” “operatively coupled,” “connected”, “connecting,” “electrically connected,” etc., are used interchangeably herein to generally refer to the condition of being electrically/electronically connected in an operative manner. Similarly, a first entity is considered to be in “communication” with a second entity (or entities) when the first entity electrically sends and/or receives information signals (whether containing address, data, or control information) to/from the second entity regardless of the type (analog or digital) of those signals. It is further noted that various figures (including component diagrams) shown and discussed herein are for illustrative purpose only, and are not drawn to scale.

The terms “first,” “second,” etc., as used herein, are used as labels for nouns that they precede, and do not imply any type of ordering (e.g., spatial, temporal, logical, etc.) unless explicitly defined as such.

Conventional vision or image sensors capture a series of still frames, as in conventional video and computer vision systems. Each “frame” is associated with a pre-defined size of pixel array, typically all the pixels of the image sensor exposed to the luminance being sensed. As is understood, a “pixel” is a basic unit of an image sensor and can be considered as the smallest controllable element of an image sensor. In conventional image sensors, successive frames contain enormous amounts of redundant information, wasting memory space, energy, computational power, and time. In addition, in a frame-based sensing approach, each frame imposes the same exposure time on every pixel in the frame, thereby making it difficult to deal with scenes containing very dark and very bright regions.

Event-Driven vision sensing is a new way of sensing visual reality in a frame-free manner. Event-Driven vision sensors provide visual information in quite a different way from the conventional video systems, which provide sequences of still images rendered at a given “frame rate.” In an Event-Driven vision sensor, each pixel autonomously and asynchronously sends out an “event” or spike when it senses something meaningful is happening, without any notion of a frame. A special type of Event-Driven sensor is a Dynamic Vision Sensor (DVS), which is an imaging sensor that only detects motion in a scene. A DVS contains an array of pixels where each pixel computes relative changes of light or “temporal contrast.” Each pixel then outputs an Address Event (AE) (or, simply, an “event”) when local relative intensity changes exceed a global threshold. In a DVS, instead of wastefully sending entire images at fixed frame rates, only the local pixel-level changes caused by the movement in a scene are transmitted at the time they occur. Thus, the output of a DVS consists of a continuous flow of pixel events that represent the moving objects in the scene. These pixel events become available at microsecond time resolution, equivalent to or better than conventional high-speed vision sensors running at thousands of frames per second. These events can be processed “as they flow” by a cascade of event (convolution) processors. As a result, input and output event flows at a processor are practically coincident in time, and objects can be recognized as soon as the DVS provides enough meaningful events.

In a DVS, each pixel autonomously computes the normalized time derivative of the sensed light and provides an output event with pixel's (x, y) coordinates when this derivative exceeds a pre-set threshold contrast. A DVS is also referred to as an “asynchronous temporal vision contrast sensor” because it provides frame-free event-driven asynchronous low data rate visual information. Given certain integration time, a DVS sensor outputs asynchronous stream of pixel AEs that directly encode scene reflectance changes. Unlike conventional cameras, DVS cameras only respond to pixels with temporal luminance differences. As a result, DVS cameras can greatly reduce power, data storage, and computational requirements associated with processing of motion-sensing data and significantly improve the efficiency of post-processing stages. A DVS sensor's dynamic range is also increased by orders of magnitude due to local processing. DVS cameras have unique features such as contrast coding under very wide illumination variations, microsecond latency response to fast stimuli, and low output data rate. These cameras can track extremely fast objects without special lighting conditions. Hence, DVS cameras find applications, for example, in the fields of traffic/factory surveillance and ambient sensing, motion analyses (e.g., gesture recognition, face/head detection and recognition, car or other object detection, user recognition, human or animal motion analysis, etc.), fast robotics, and microscopic dynamic observation (e.g., particle tracking, and hydrodynamics).

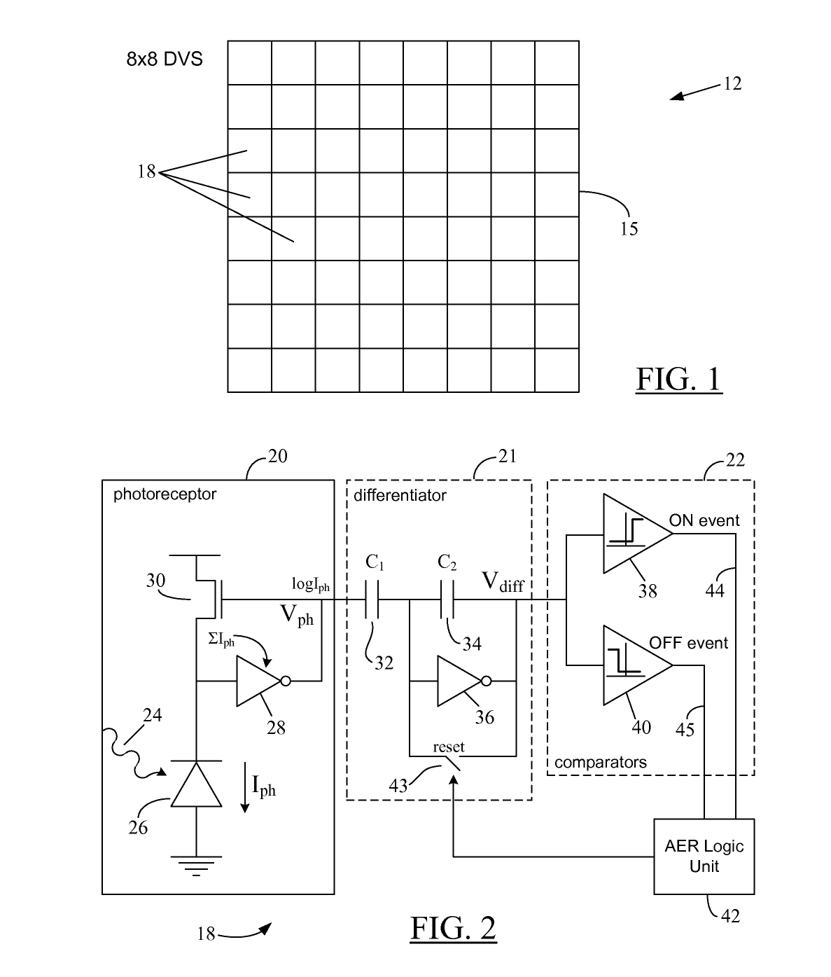

FIG. 1 shows a conventional DVS 12 having an 8×8 pixel array 15. The pixel array 15 is shown to include 64 pixels or pixel locations. Because of typically identical construction of each pixel in the pixel array 15, each pixel or pixel location in the array 15 is identified using the same reference numeral “18” for ease of discussion.

FIG. 2 depicts the pixel circuit of each pixel 18 in the pixel array 15 of FIG. 1. As shown in FIG. 2, each pixel or pixel location 18 may include a photoreceptor 20, a differentiator unit 21, and a comparator unit 22. The pixel 18 uses an active continuous-time logarithmic photoreceptor 20 followed by a well-matched self-timed switched-capacitor differentiator amplifier 21. For the temporal contrast computation, each pixel 18 in the DVS 12 continuously monitors its photocurrent for changes. The incident luminance 24 is received by a photodiode 26, which, in turn, generates corresponding photocurrent Iₚₕ. All the photocurrent (ΣIₚₕ) generated during a sampling period is logarithmically encoded (log Iₚₕ) by an inverter 28 into the photoreceptor output voltage Vₚₕ. A source-follower buffer 30 isolates the photoreceptor 20 from the next stage 21. Thus, the photoreceptor 20 functions as a transducer to convert received luminance/light signal into a corresponding electrical voltage Vₚₕ. The self-timed switched-capacitor differencing amplifier 21 amplifies the deviation in the photocurrent's log intensity (log Iₚₕ) from the differentiator unit-specific last reset level. The matching of the local capacitors C₁ and C₂ (identified by reference numerals “32” and “34”, respectively) gives the differencing circuit 21 a precisely defined gain for amplifying the changes in log intensity. The difference voltage V_{diff} at the output of the inverting amplifier 36 may be given by: V_{diff}=A.d(log Iₚₕ), where “A” represents the amplification gain of the differentiator unit 21 and “d(log Iₚₕ)” is the differentiation of the log intensity. The comparator unit 22 detects positive and negative changes in the log intensity through quantization and comparison. In the comparator unit 22, the deviation V_{diff} is continuously compared against two thresholds. The comparator unit 22 includes two comparators 38, 40, each comparator providing one of the two thresholds for comparison. As soon as either of the two comparator thresholds is crossed, an Address Event (AE) (or, simply, an “event”) is communicated to a pixel-specific Address Event Representation (AER) logic unit 42 and the switched-capacitor amplifier/differentiator 21 is reset—as symbolically illustrated by a switch 43—to store the new illumination level until next sampling interval. The pixel 18 thus performs a data-driven Analog-to-Digital (AD) conversion.

An increase in the intensity of the incident light 24 leads to an “ON event,” whereas a decrease produces an “OFF event.” As shown in FIG. 2, the comparator 38 responds with an “ON event” signal 44 representing a fractional increase in the received luminance that exceeds a comparator-specific tunable threshold. Similarly, the comparator 40 responds with an “OFF event” signal 45 when a fractional decrease in the received luminance exceeds a comparator-specific tunable threshold. The ON and OFF events are communicated asynchronously to a digital control module (not shown in FIG. 2) in the DVS 12 using AER. This approach makes efficient use of the AER protocol because events are communicated immediately, while pixels that sense no changes are silent. For each pixel 18 in the DVS 12, the digital control module includes a pixel-specific AER logic unit such as, for example, the unit 42. To communicate the DVS events, the sensor 12 may use word serial burst mode AER circuits in the digital control module. If V_{diff} crosses the threshold of either comparator 38 or 40, the pixel 18 may first request in the row direction. A non-greedy arbitration circuit (not shown) in the digital control module may choose among all requesting rows and acknowledge a single row at a time. In this selected row, all pixels that have crossed the threshold (for ON event or OFF event) may assert a corresponding request signal in the column direction. A small asynchronous state machine in each column may latch the state of the request lines (whether requesting or not). A simplified arbitration tree may choose the leftmost requesting column and all addresses of the requesting columns are then sequentially read out. Thus, all events in a column burst receive the same timestamp in microsecond resolution. Different rows may be sequentially selected during a sampling interval to perform the motion detection. Given certain integration time, the output of the sensor 12 contains an asynchronous stream of pixel address events that directly encode the changes in the reflectance of the scene being monitored/detected.

It is observed from the pixel configuration in FIG. 2 that each pixel 18 has many transistors whose size is hard to reduce. Hence, the spatial resolution of the pixel 18 in the conventional DVS 12 is difficult to increase. This drawback adversely impacts the utility of a conventional DVS (like the DVS 12) for applications such as gesture recognition or user recognition where higher performance may be accomplished when the sensor's spatial resolution is higher.

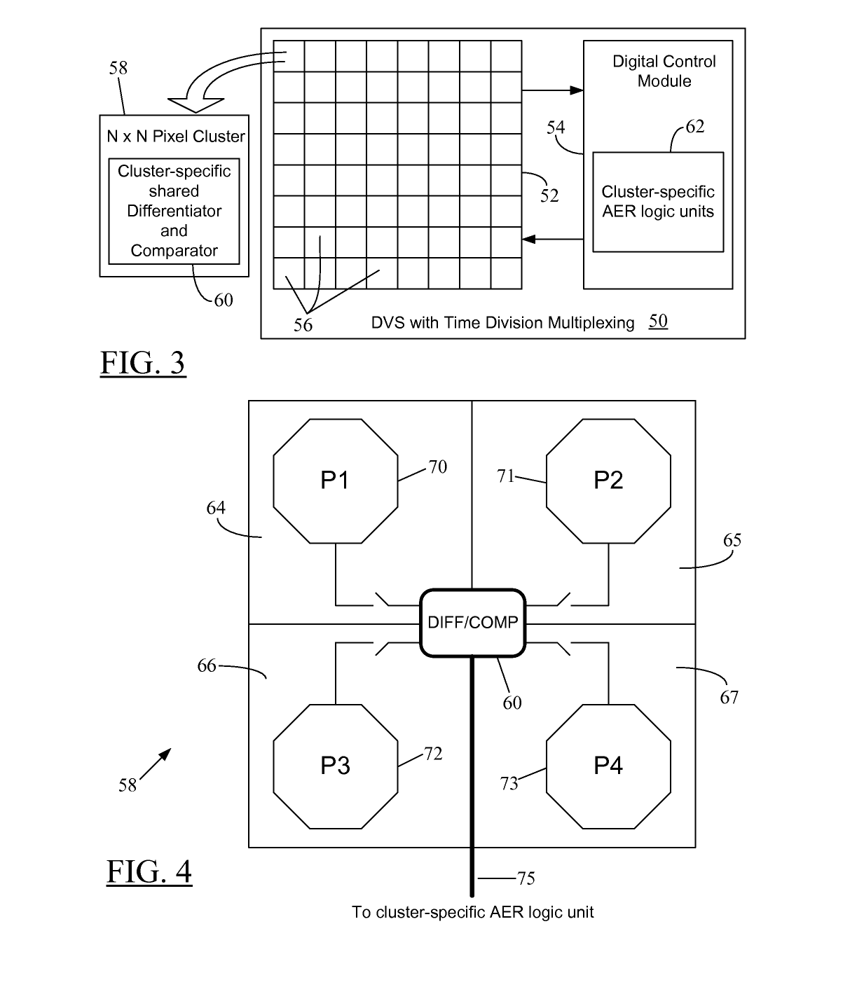

FIG. 3 illustrates a block diagram of an exemplary DVS 50 according to one embodiment of the present disclosure. The DVS 50 provides increased spatial resolution by reducing pixel pitch. As shown, the DVS 50 may include a pixel array 52 coupled to a digital control module 54. For ease of illustration, only an 8×8 pixel array 52 is shown in FIG. 2. However, it is understood that the pixel array 52 may be of any other size depending on design considerations. Because of substantially identical construction of each pixel in the pixel array 52, each pixel or pixel location in the array 52 is identified using the same reference numeral “56” for ease of discussion. Contrary to the pixel array 15 in the conventional DVS 12 in FIG. 1, each pixel location 56 in the pixel array 52 comprises multiple pixels—here, a cluster of N×N pixels 58. Alternatively, a “pixel” 56 in the pixel array 52 may be considered to consist of not a single pixel, but rather an N×N array of sub-pixels. However, for ease of discussion, the terms “pixel” and “sub-pixel” may be used interchangeably herein to essentially refer to a single pixel of the N×N pixel cluster at each pixel location 56 in the pixel array 52. In an embodiment where N=2, each pixel 56 in the pixel array 52 is essentially a 2×2 pixel cluster as shown in FIG. 4 (discussed later below). When N=2, there will be a total of 64×4=256 discrete pixels in the 8×8 pixel array 52.

Each N×N pixel cluster 58 may include a cluster-specific shared differentiator unit and a cluster-specific shared comparator unit as symbolically illustrated by block 60 in FIG. 3. In other words, all pixels in a pixel cluster share a common differentiator and a common comparator, thereby reducing the pixel pitch. In one embodiment, each pixel in a pixel cluster may share the common differentiator and comparator units using Time Division Multiplexing (TDM) techniques for higher spatial resolution and better linear separation of pixel data. The digital control module 54 may include a plurality of cluster-specific AER logic units as indicated by block 62 in FIG. 3. Thus, instead of a pixel-specific AER logic unit (like the unit 42 in FIG. 2), the cluster-specific AER logic unit in the embodiment of FIG. 3 is shared among all pixels in the corresponding pixel cluster. Because of the shared pixel design, the physical size or chip area taken up by the 8×8 pixel array 52 may be the same as that of the 8×8 pixel array 15 in a conventional DVS. However, in the pixel array 15, there is only one pixel at the pixel location 18, whereas there are multiple shared pixels (in an N×N pixel cluster format) at the pixel location 56 in the pixel array 52 according to the teachings of the present disclosure, thereby reducing pixel pitch.

FIG. 4 is an exemplary architectural layout of a 2×2 pixel cluster in the DVS 50 of FIG. 3 according to one embodiment of the present disclosure. The 2×2 pixel cluster in FIG. 4 represents the N×N pixel cluster 58 in FIG. 3, when N=2. Hence, for ease of discussion, the same reference numeral “58” is used in FIG. 4 to refer to the 2×2 pixel cluster. The 2×2 pixel cluster 58 includes four pixels or sub-pixels 64-67, wherein each such pixel/sub-pixel includes a pixel-specific photoreceptor unit 70-73, respectively. Thus, as shown, the pixel cluster 58 includes 4 photoreceptors 70-73 in the 2×2 configuration. More generally, an N×N pixel cluster according to one embodiment of the present disclosure would include N×N photoreceptors. It is noted here that for ease of illustration each pixel (or sub-pixel) 64-67 is shown as square-shaped. However, in particular embodiments, the actual physical shape of the pixels 64-67 may be square, rectangular, circular, hexagonal, or any other suitable shape selected as per design considerations. Furthermore, for ease of illustration and discussion, the 2×2 pixel cluster 58 is used as an example. The discussion applicable to the 2×2 pixel cluster 58 also remains applicable to any other N×N pixel cluster configured according to the teachings of the present disclosure.

In one embodiment, each photoreceptor 70-73 may have a circuit configuration similar to the photoreceptor 20 shown in FIG. 2 and, hence, additional discussion of photoreceptors 70-73 is not provided in view of the discussion of photoreceptor 20. As shown in FIG. 4, each photoreceptor 70-73 shares a cluster-specific differentiator unit and a cluster-specific comparator unit—both of which are collectively identified by the reference numeral “60” in FIGS. 3 and 4 for ease of illustration and discussion only. In one embodiment, the common differentiator unit may have circuit configuration similar to the differentiator unit 21 in FIG. 2, and the common comparator unit may have circuit configuration similar to the comparator unit 22 in FIG. 2. Hence, additional discussion of the shared differentiator/comparator unit 60 is not provided herein for the sake of brevity. Because multiple adjacent photoreceptors share the same differentiator and the same comparator units in TDM fashion, spatial resolution of the DVS 50 is improved. Thus, instead of using a dedicated differentiator 21 and a dedicated comparator 22 in one-to-one correspondence with the photoreceptor 20 as in case of the pixel 18 in FIG. 1, the shared pixel configuration of pixel array 52 uses a common, cluster-specific differentiator and comparator in a many-to-one correspondence with the photoreceptors 70-73.

It is seen from FIG. 4 that a portion of each pixel 64-67 is shared by other pixels in the pixel cluster 58. The shared portion includes the cluster-specific differentiator and comparator units 60. Hence, the pixel array 52 in the DVS 50 according to the teachings of the present disclosure may be considered to effectively consist of “shared pixels.”

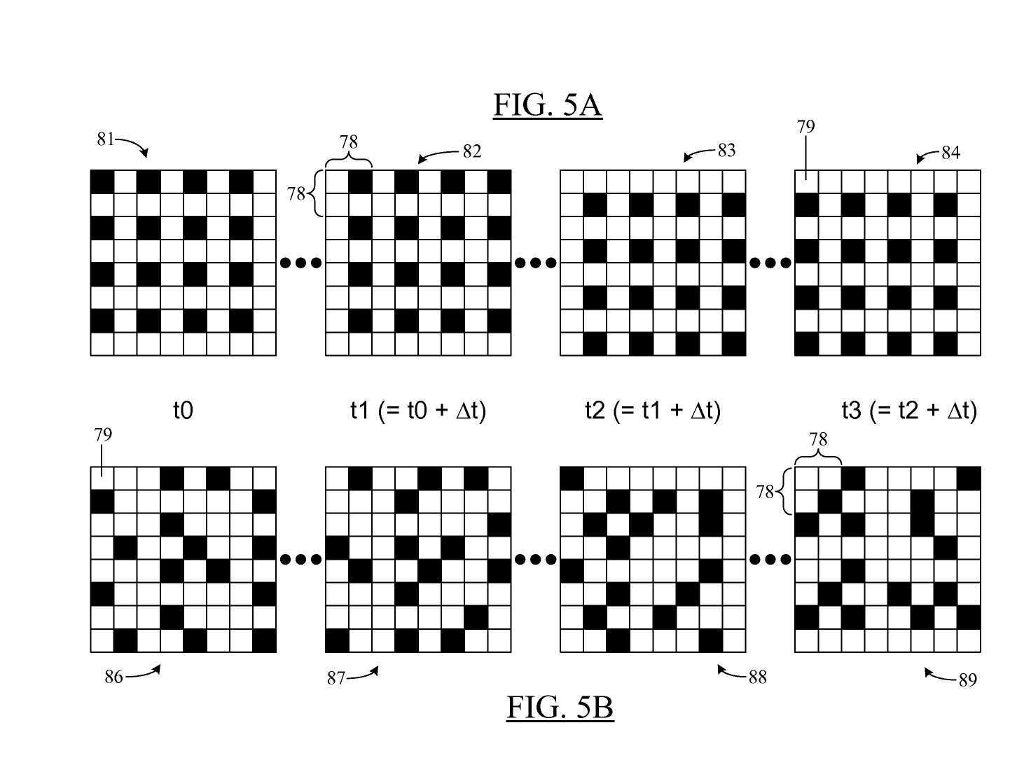

In one embodiment, because of TDM, only one of the photoreceptors 70-73 in the pixel cluster 58 may be connected to the shared differentiator/comparator unit 60 at a time. The same may apply to each pixel cluster in the pixel array 52. Hence, as a result, only one quarter of the whole pixel array 52 may be in use at the same time as shown in more detail in the exemplary embodiments of FIGS. 5A-5B (discussed later below). In one embodiment, the digital control module 54 may select only one pixel at a time from each pixel cluster 58 in the pixel array 52 so as to use only a quarter of all pixels at a time during read-out of pixel event signals. To accomplish the TDM-based selection of pixel outputs, the digital control module 54 may sequentially connect the cluster-specific differentiator unit (and, hence, the cluster-specific comparator unit as well) 60 to a different one of the 2×2 photoreceptors 70-73 to receive corresponding electrical signal from each photoreceptor in the pixel cluster 58. In particular embodiments, the sequential connection may be based on a fixed order of selection (as shown, for example, in FIG. 5A) or a pseudo-random order of selection (as shown, for example, in FIG. 5B). In one embodiment, the digital control module 54 may connect the cluster-specific differentiator/comparator unit 60 to a different one of the 2×2 photoreceptors 70-73 in a periodic manner.

The common differentiator in the shared unit 60 may be configured to be reset prior to each sequential connection to a different one of the 2×2 photoreceptors 70-73. In particular embodiments, the digital control module may be configured to reset the cluster-specific differentiator unit in one of the following two ways: (i) periodically at a pre-determined time interval such as, for example, after every 1 ms time interval, or (ii) whenever the cluster-specific comparator in the shared unit 60 communicates a pixel event signal to the digital control module—more specifically, to the cluster-specific AER logic unit 62 in the digital control module 54 associated with the pixel cluster 58. In FIG. 4, the reference numeral “75” indicates communication of pixel-specific event signals from the shared comparator 60 to the cluster-specific AER logic unit 62 in the digital control module 54.

In one embodiment, all cluster-specific differentiators in the pixel array 52 may be globally reset periodically. After every global reset, the digital control module 54 may switch the cluster-specific differentiators to another quarter of pixels for detection.

It is observed from the discussion of FIGS. 3-4 that the pixel-sharing approach according to particular embodiments of the present disclosure results in smaller pixels (i.e., reduced pixel pitch) per pixel location 56. Smaller pixels enable higher spatial resolution. Furthermore, the clustering and TDM-based pixel-sharing may effectively result in reduced AER bandwidth per pixel in the sense that the same row/column address may be used by an AER logic unit 62 in the control module 54 to access four different pixels 64-67 in the 2×2 pixel cluster 58 instead of just one pixel 18 as in case of the AER logic unit 42 associated with the conventional pixel array 15. In the embodiments of FIGS. 3-4, each cluster-specific AER logic unit 62 simply connects to a single unit—i.e., the corresponding shared differentiator/comparator unit 60, regardless of the total number of pixels sharing this unit 60 in a switched manner. Hence, the AER bandwidth per pixel is reduced.

FIGS. 5A and 5B illustrate two exemplary pixel switching patterns for the pixel array 52 in FIG. 3 according to particular embodiments of the present disclosure. One of these pixel switching patterns may be employed by the digital control module 54 to sample the pixels in the pixel array 52 to collect available pixel event signals. It is noted here that a pixel may not output a photoreceptor-specific pixel event signal (such as, for example, at the output 75 in FIG. 4) for that pixel when the pixel has no event to report. However, through the sampling patterns shown in FIGS. 5A-5B, the photoreceptor in such “non-reporting” pixel may still periodically get connected to the cluster-specific common differentiator/comparator unit to enable the control module 54 to receive a photoreceptor-specific pixel event signal whenever it becomes available.

For ease of illustration, each pixel is individually shown in FIGS. 5A and 5B and only four discrete 2×2 pixel clusters (i.e., a total of 64 pixels) are shown in FIGS. 5A-5B instead of the total of eight 2×2 pixel clusters (i.e., a total of 256 pixels) in the pixel array 52. However, it is understood that the sampling patterns shown in FIGS. 5A-5B apply to all the pixels in the pixel array 52, and not just to the portion of the array 52 shown in FIGS. 5A-5B. An exemplary 2×2 pixel cluster, like the pixel cluster 58 in FIG. 4, is identified by the reference numeral “78” in FIGS. 5A-5B. In the embodiment of FIG. 5A, pixels in a pixel cluster are spatially sparse sampled with a regular pattern using a fixed order of selection—here, a clockwise order of selection starting with the top left pixel in each pixel cluster. In case of the pixel cluster 78, the top left pixel is identified by reference numeral “79.” The progression of sampling is illustrated via patterns 81-84 in FIG. 5A associated with time instances t₀, t₁ (=t₀+Δt), t₂ (=t₁+Δt), and t₃(=t₂+Δt), respectively. In the embodiment of FIG. 5B, however, pixels in a pixel cluster are spatially sparse sampled using a pseudo-random order of selection as indicated by exemplary sampling patterns 86-89 associated with time instances t₀, t₁ (=t₀+Δt), t₂ (=t₁+Δt), and t₃(=t₂+Δt), respectively. In FIGS. 5A-5B, the sampled pixels are indicated by darkened squares. Other sampling patterns may be devised to suitably sample all the pixels in the pixel array 52.

It is observed from FIGS. 5A-5B that a discrete or different pixel is sequentially sampled during each sampling interval. In other words, the sampling location may be changed after a pre-defined sampling time interval At, so that sparse samples (collected from each quarter of pixels) are compensated in time domain. As noted earlier, because of time division multiplexing, only one quarter of pixels in the array 52 may be in use at the same time. Hence, periodic sequential sampling (after each time interval of Δt) in the manner illustrated in the exemplary embodiments of FIGS. 5A-5B may be performed by the digital control module 54 so that sparse samples are compensated in time domain. Because of only one quarter of pixels in use at a given time due to TDM, the pixel data bandwidth to the AER logic units 62 may be reduced, for example, as compared to the sampling of all available pixels. Furthermore, there may be less events to record during a specific sampling interval, and there may be less bits assigned for AER addresses as well (as discussed earlier) when the TDM-based DVS according to particular embodiments of the present disclosure is employed.

In one embodiment, after each sampling interval At, the common differentiator in each pixel cluster may be reset by the control module 54 prior to the differentiator's next sequential connection to a different one of the 2×2 photoreceptors. Thus, all cluster-specific differentiators in the pixel array 52 may be globally reset periodically. After every global reset, the digital control module 54 may switch the cluster-specific differentiators to another quarter of pixels for detection.

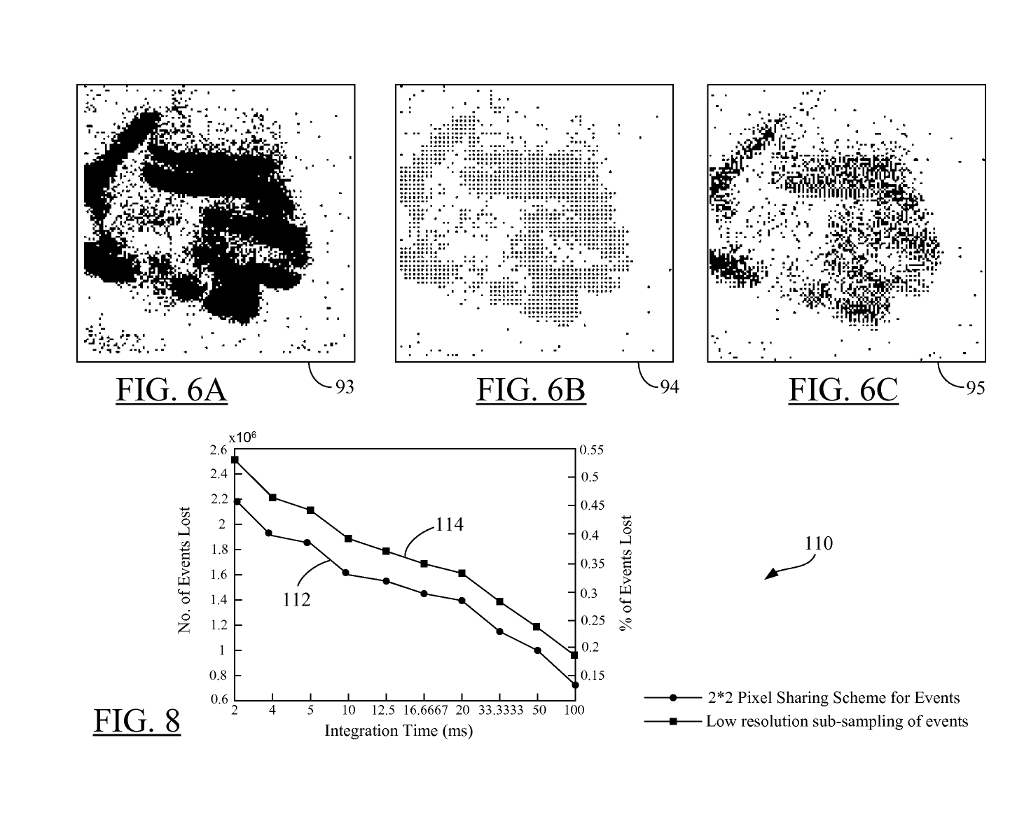

FIGS. 6A-6C are exemplary gesture recognition plots 93-95 comparing the resolution of the output of a 2×2 pixel-sharing scheme according to the teachings of particular embodiments of the present disclosure against the resolutions of two other types of outputs. Each plot 93-95 in FIGS. 6A-6C is captured from the pixel events/outputs using the integration time of 33.33 ms (milliseconds). The hand gesture captured in plot 93 in FIG. 6A relates to the simulation of a time-integrated output at full resolution from a DVS design that has the same number of pixels as a DVS (e.g., the DVS 50) according to one embodiment of the present disclosure, but that does not employ the pixel-sharing as described herein. Thus, in the plot 93 in FIG. 6A, outputs from all of pixels are collected and integrated, resulting in a full resolution output of a hand gesture. The plot 93 may represent an “ideal” plot in the sense that it is simulated for a DVS that has a reduced pixel pitch like the DVS 50, but that does not need pixel sharing to accommodate the increased spatial resolution. On the other hand, the plot 94 in FIG. 6B relates to hand gesture captured by integrating pixel events from only a single, pre-determined quarter of pixels in a TDM-based DVS design such as, for example, the DVS 50 in FIG. 3. In the low resolution plot 94 of FIG. 6B, pixel switching is not performed. Hence, the events associated with the missing pixels—i.e., the three quarters of pixels whose outputs are not integrated—are displayed by adding a binary zero (0) bit to the locations associated with those missing pixels. Effectively, the low resolution plot 94 may represent the output of a conventional DVS (such as the DVS 12 in FIG. 1) whose pixel array has one fourth of the pixels as compared to a 2×2 pixel cluster-based pixel array in a DVS (such as the DVS 50 in FIG. 3) according to the teachings of the present disclosure. Finally, the hand gesture plot 95 in FIG. 6C relates to the pixel events integrated in a time division multiplexed manner from all pixels in a pixel array with 2×2 pixel clusters, such as, for example, the pixel array 52 in FIG. 3 with 2×2 pixel clusters 58 of FIG. 4. The time division multiplexing may be performed using, for example, a regular pixel switching pattern of FIG. 5A or a pseudo-random pixel switching pattern of FIG. 5B. It is observed that although the 2×2 pixel sharing scheme according to the teachings of the present disclosure provides a DVS design that has inferior resolution (plot 95 in FIG. 6C) as compared to the “ideal” output in FIG. 6A, the 2×2 pixel sharing scheme still provides improved resolution (and, hence, enhanced information) as compared to the low resolution output in FIG. 6B (which also represents the output of a conventional DVS as noted above).

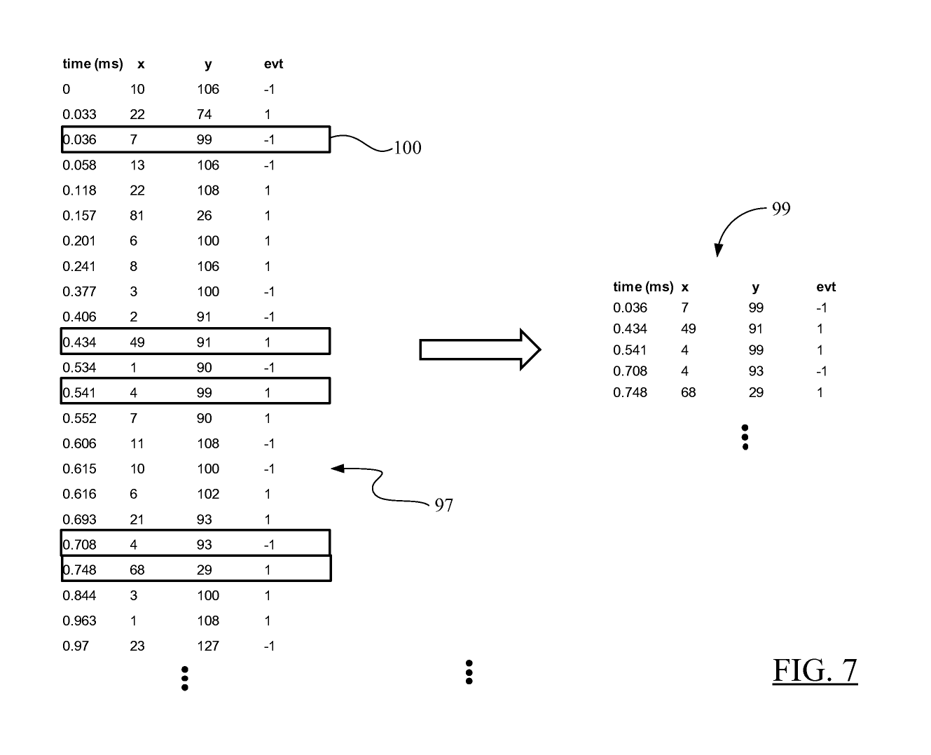

FIG. 7 shows results of an exemplary simulation of event data counts for a full resolution based pixel output scheme and a 2×2 shared pixel scheme according to one embodiment of the present disclosure. The full resolution scheme may be the same as that mentioned earlier with reference to FIG. 6A. That is, the full resolution scheme may represent an “ideal” DVS that has a reduced pixel pitch like the DVS 50, but that does not need pixel sharing to accommodate the increased spatial resolution. In FIG. 7, the listing 97 refers to pixel events collected for a full resolution scheme from pixels having different (x,y) coordinates. The time (in ms) represents the time when a corresponding pixel reports an event. The “evt” column refers to the type of the event being reported by a pixel—a negative one (“−1”) value refers to an “OFF event”, whereas a positive one (“1”) value refers to an “ON event.” The listing 99 refers to pixel events reported/communicated to a control module such as, for example, the control module 54 in FIG. 3, in a 2×2 pixel-sharing scheme employing TDM-based sampling of pixel events as, for example, in case of the DVS 50 in FIG. 3 having the 2×2 pixel clusters of FIG. 4. It is observed from a comparison of listings 97 and 99 that the events included in the listing 99 are only those events which are highlighted using rectangular blocks (such as, for example, the block 100) in the listing 97. In other words, some events may be missed when pixel sharing and TDM-based sampling according to teachings of the present disclosure are employed. However, the lost events may not significantly negatively impact the performance as can be observed from the earlier discussion of comparison of FIGS. 6A and 6C.

FIG. 8 is an exemplary simulation plot 110 showing graphs 112, 114 comparing the number of events lost in case of a TDM-based 2×2 pixel sharing scheme according to the teachings of the present disclosure and in case of low resolution sub-sampling of pixels. The graph with reference numeral “112” relates to the 2×2 pixel sharing scheme, whereas the other graph with reference numeral “114” relates to the low resolution sampling approach. The low resolution approach is similar to that discussed earlier with reference to FIG. 6B—i.e., when only one quarter of pixel outputs are recorded without sequential sampling/selection of remaining quarters of pixels. The lost events in each case may be computed based on the difference between sub-sampled events and original events. For example, FIG. 7 depicts such lost events in case of a 2×2 pixel sharing scheme when compared with the original events recorded for a full resolution scheme. It is seen from FIG. 8 that percentage of lost events is reduced when the integration time becomes longer. Different integration times are noted in milliseconds along the x-axis in FIG. 8. The number of lost events and the percentage of lost events are marked along left and the right y-axes, respectively. It is also seen from FIG. 8 that less events are lost—i.e., more visual information or content is maintained—when a 2×2 pixel sharing scheme as per particular embodiments of the present disclosure is used for original events than low-resolution sub-sampling of events.

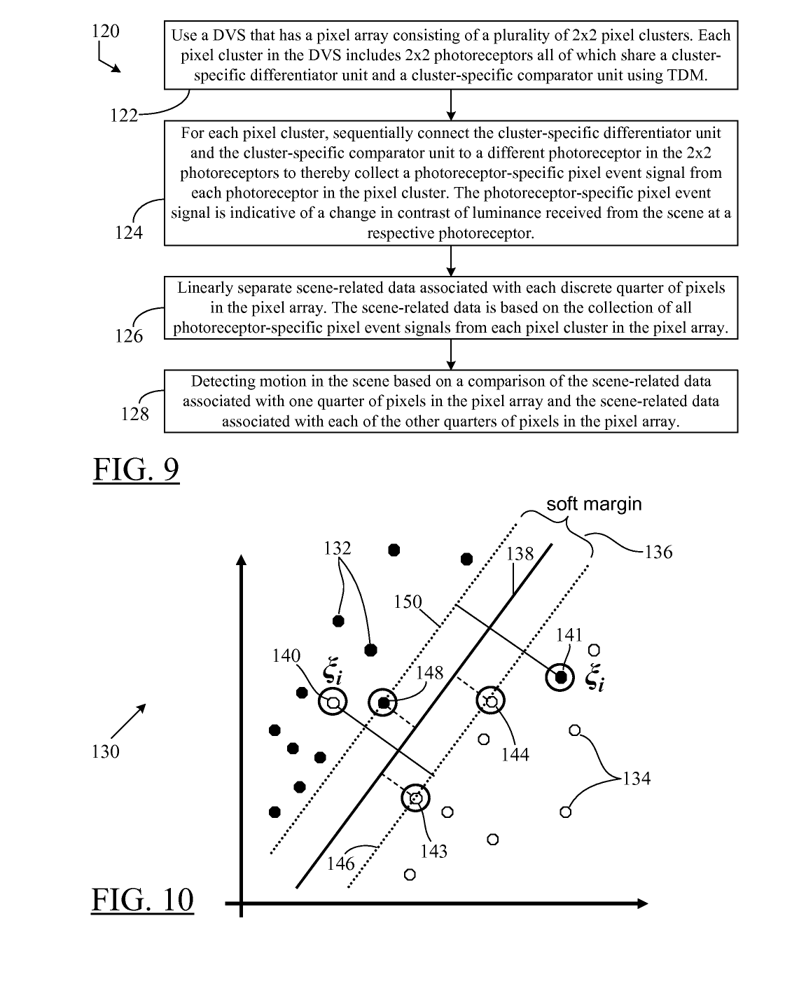

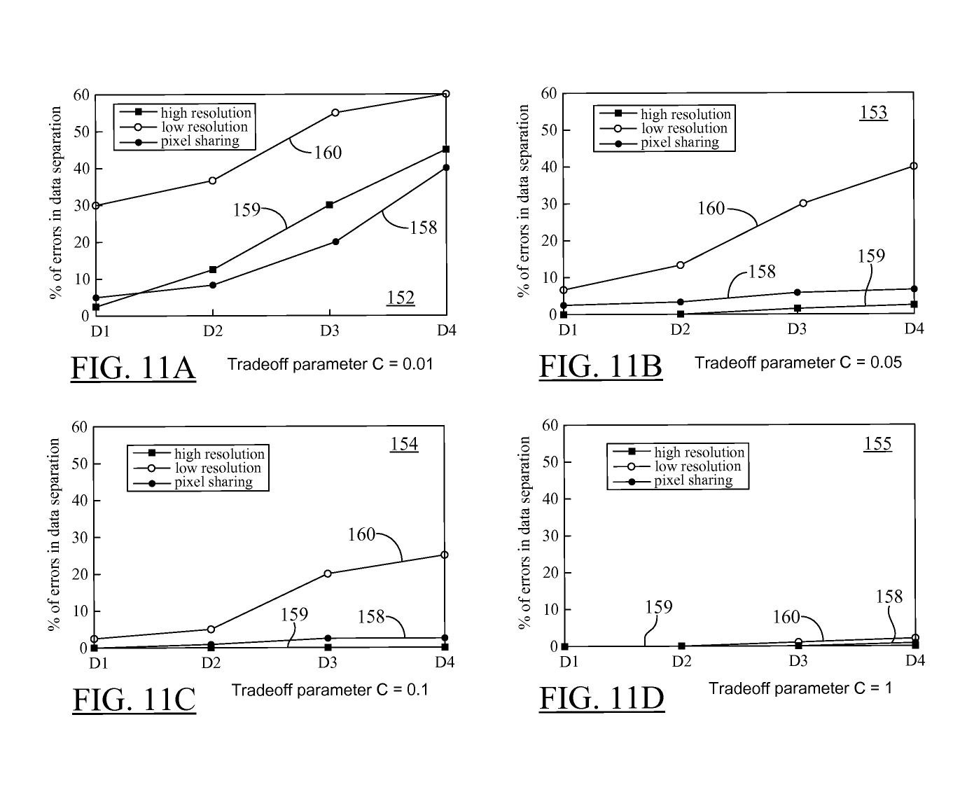

FIG. 9 shows an exemplary flowchart 120 for a method of detecting motion in a scene according to one embodiment of the present disclosure. As noted at block 122, the method may use a DVS such as, for example, the DVS 50 in FIG. 3, that has a pixel array such as, for example, the pixel array 52, which consists of a plurality of 2×2 pixel clusters, like the pixel cluster 58 in FIG. 4. As explained earlier, each pixel cluster 58 in the DVS 50 includes 2×2 photoreceptors 70-73 all of which share a cluster-specific differentiator/comparator unit 60 using time division multiplexing (TDM). At block 124, for each pixel cluster, the method comprises sequentially connecting the cluster-specific differentiator/comparator unit 60 to a different photoreceptor in the 2×2 photoreceptors to thereby collect a photoreceptor-specific pixel event signal from each photoreceptor in the pixel cluster. For example, the photoreceptor-specific pixel event signal for the pixel cluster 58 in FIG. 4 may be available at the output 75 and may be indicative of a change in contrast of luminance received from the scene at the respective photoreceptor associated with the pixel event signal. As mentioned earlier, in one embodiment, the TDM-based sampling of pixels in 2×2 pixel clusters in a pixel array such as, for example, the pixel array 52, may result in selection of only one quarter of pixels in the pixel array during a specific sampling interval. Hence, at block 126, the method may include the step of linearly separating scene-related data associated with each discrete quarter of pixels in the pixel array 52. The scene-related data may be based on the collection of all photoreceptor-specific pixel event signals from each pixel cluster in the pixel array 52. In one embodiment, the linear separation at block 126 may be performed using a Support Vector Machine (SVM) model discussed below with reference to FIGS. 10-11. At block 128, the motion in the scene may be detected based on a comparison of the scene-related data associated with one quarter of pixels in the pixel array and the scene-related data associated with each of the other quarters of pixels in the pixel array.

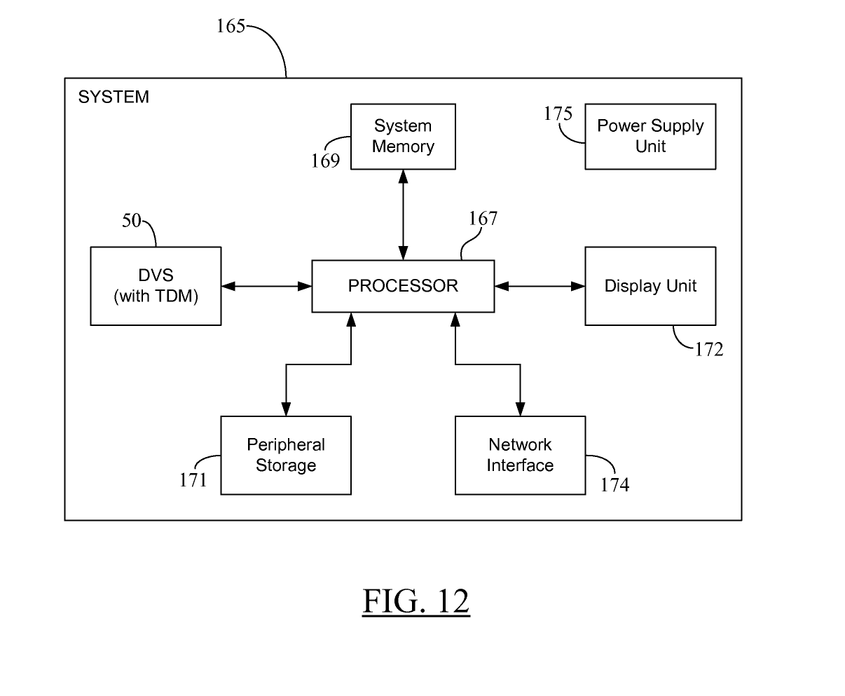

The method in FIG. 9 may be performed by using the DVS as part of a vision sensor-based system such as, for example, the system 165 shown in FIG. 12 (discussed below). As part of such a system, the steps at blocks 124, 126, and 128 may be performed by a digital control module of the DVS such as, for example, the control module 54 in FIG. 3. The digital control module 54 may be suitably configured—in hardware and/or software—to accomplish the desired tasks. Alternatively, in one embodiment, the system that includes the DVS 50 may have a processor (e.g., the processor 167 in FIG. 12) that may be suitably configured—in hardware and/or software—to communicate with the DVS 50 to perform the steps outlined at blocks 122, 124, 126, and 128. Other ways to perform the method steps in the flowchart 120 may be devised as well depending on design considerations.

It is noted here that although various steps illustrated in FIG. 9 are discussed above as being “performed” by a digital control module and/or a processor, entities other than or in addition to these units also may be involved. All of the “participating” units may be suitably configured in hardware (and, if necessary, in software such as, for example, using microcode) to enable them to “perform” the corresponding steps. On the other hand, a single entity may perform many or all of the aspects shown in FIG. 9. Thus, it may not be preferable or fruitful in particular embodiments to exactly identify each DVS-related entity or unit associated with a particular process step. Rather, it is more suitable to recognize that a DVS (e.g., the DVS 50 in FIG. 3) and/or a system (e.g., the system 165 in FIG. 12), in general, may be configured to “perform” the process steps illustrated in FIG. 9.

FIG. 10 depicts an exemplary plot 130 to illustrate a soft margin-based Support Vector Machine (SVM) model for linear classification of data. The plot 130 is shown for example data from two labels (i.e., two different classes of samples for motion detection). In one embodiment, such SVM model may be used to linearly separate pixel outputs such as, for example, as part of the method step at block 126 in FIG. 9. In machine learning, support vector machines are supervised learning models, which, along with associated learning algorithms, may be used to analyze data and recognize patterns using linear classification. Given a set of training examples, each marked as belonging to one of two pre-determined categories, an SVM training algorithm builds an SVM model that assigns new (future) examples into one category or the other, making it a binary linear classifier. An output of SVM model is thus a linear decision boundary given the distribution of examples. The decision boundary is determined by a clear gap (called “soft margin” in FIG. 10) that is as wide as possible to separate the samples belonging to different categories. After the SVM model is “trained,” new examples are then predicted to belong to one category based on which side of the decision boundary they fall on. In FIG. 10, one class of samples are represented as data points 132 (darkened hexagons) and the other class of samples are represented as data points 134 (non-darkened hexagons). The “gap” or “soft margin” between these samples is illustrated using reference numeral “136.” In one embodiment, these “samples” may be the TDM outputs of pixels from a pixel array with N×N pixel clusters such as, for example, the pixel array 52 in FIG. 3.

In an SVM model, a maximum-margin hyperplane represents the largest separation, or margin, between two classes of data points. For better linear separation of data, it is therefore desirable to choose a hyperplane such that the distance from it to the nearest data point on each side of the hyperplane is maximized. A soft margin method in SVM will choose a hyperplane that splits the examples or data points as cleanly as possible, while still maximizing the distance to the nearest cleanly split examples. In FIG. 10, an exemplary maximum soft margin-based hyperplane is identified by the line 138. As can be seen, the hyperplane 138 maximally separates the two classes of data points 132, 134. The soft margin method may use non-negative slack variables, ξᵢ, which measure the degree of misclassification of data points—here, the data points 140, 141. The samples/data points on the margin may define support vectors of the hyperplane 138. In FIG. 10, the data points 143-144 define a support vector 146, whereas the data point 148 defines a support vector 150.

There are a number of learning parameters that can be utilized in constructing SV machines. The penalty parameter “C” is one of them and may be chosen by a user. The C parameter controls the misclassification of training samples; it informs the SVM model how to avoid misclassifying the training samples/data points. As noted above, in an SVM model, it is desirable to maximize the margin hyperplane, such as, for example, the hyperplane 138, that can linearly maximally separate two classes of samples such as, for example, the samples 132 and 134. When the margin hyperplane is gradually increased, the samples may start getting misclassified. For large values of C, the SVM model may lead to a smaller-margin hyperplane if that hyperplane does a better job of getting all the training samples classified correctly. Conversely, a very small value of C will cause the SVM model to look for a larger-margin hyperplane, even if that hyperplane misclassifies more points (i.e., increases training error). Hence, for very tiny values of C, the SVM model will provide misclassified examples, often even if the training data is linearly separable.

From the above discussion, it is observed that the parameter C controls the number of errors allowed; the larger the value of C, the smaller the number of errors allowed. The parameter C affects the tradeoff between complexity of an SVM model and training error (i.e., proportion of non-separable samples). Hence, in practice, a proper value of C may be selected by a user to obtain a hyperplane that provides optimal linear separation of data points (such as, for example, pixel event data) without overloading the SVM model with complexity.

FIGS. 11A-11D illustrate performance simulation plots 152-154, respectively, showing the effect of different values of the tradeoff parameter C on data separation for three types of DVS resolution schemes. For a selected value of parameter C, each plot depicts the performance of a DVS resolution scheme—as measured in terms of percentage of errors in data separation—when scene-related pixel data are collected from different distances D1 through D4 (representing sensor distances close to far) at the rate of 30 frames per second (fps). As can be seen, the value of C is varied from “0.01” in FIG. 11A to its maximum value of “1” in FIG. 11D. In each plot 152-154, the graph 158 (with darkened circles) relates to the 2×2 pixel sharing scheme according to one embodiment of the present disclosure (such as, for example, the pixel-sharing scheme discussed earlier with reference to FIG. 6C), the graph 159 (with darkened squares) relates to a high resolution scheme (such as, for example, the full resolution scheme without pixel-sharing as discussed earlier with reference to FIG. 6A), and the graph 160 (with non-darkened circles) relates to a low resolution scheme (such as, for example, the single quarter of pixels-based scheme without pixel switching discussed earlier with reference to FIG. 6B).

It is observed from the graphs 158-160 in FIGS. 11A-11D that, for the same value of the tradeoff parameter C, the pixel-sharing scheme according to the teachings of particular embodiments of the present disclosure performs better linear separation than the reduced resolution scheme, and substantially comparable linear separation to the high resolution scheme. It is noted here that, in particular embodiments, the pixel-sharing scheme may use the SVM-based maximum soft margin approach discussed earlier with reference to FIG. 10 for data separation. The longer distance may present more challenges to separate the data using the maximum soft margin approach, but the performance of the pixel-sharing scheme still remains comparable to the high resolution scheme. The pixel-sharing scheme may provide better data separation compared to reduced resolution scheme because of TDM where temporal sampling/switching of pixels maintains more events that are useful for better data separation.

FIG. 12 depicts an exemplary system or apparatus 165 that includes the DVS 50 of FIG. 3 according to one embodiment of the present disclosure. As discussed earlier, the DVS 50 may include the hardware shown in the exemplary embodiments of FIGS. 3 and 4 to accomplish shared pixel-based motion detection as per the inventive aspects of the present disclosure. The system 165 may include a processor 167 that is coupled to the DVS 50 and configured to interface with a number of external devices. The DVS 50 may function as an input device that provides data inputs (in the form of pixel event data) to the processor 167 for further processing. The system 165 may be a computer or computing unit, in which the processor 167 may also receive inputs from other input devices (not shown) such as a computer keyboard, a touchpad, and/or a computer mouse/pointing device. In FIG. 12, the processor 167 is shown coupled to a system memory 169, a peripheral storage unit 171, one or more output devices 172, and a network interface unit 174. In FIG. 12, a display unit is shown as an output device 172. In some embodiments, the system 165 may include more than one instance of the devices shown. Some examples of the system 165 include a computer system (desktop or laptop), a tablet computer, a mobile device, a cellular phone, a video gaming unit or console, a machine-to-machine (M2M) communication unit, a stateless “thin” client system, or any other type of computing or data processing device. In various embodiments, the system 165 may be configured as a standalone system or in any other suitable form factor. In some embodiment, the system 165 may be configured as a client system rather than a server system.

In particular embodiments, the system 165 may include more than one processor (e.g., in a distributed processing configuration). When the system 165 is a multiprocessor system, there may be more than one instance of the processor 167 or there may be multiple processors coupled to the processor 167 via their respective interfaces (not shown).

In various embodiments, the system memory 169 may comprise any suitable type of memory, such as Fully Buffered Dual Inline Memory Module (FB-DIMM), Double Data Rate or Double Data Rate 2, 3, or 4 Synchronous Dynamic Random Access Memory (DDR/DDR2/DDR3/DDR4 SDRAM), or Rambus® DRAM, flash memory, various types of Read Only Memory (ROM), etc. In some embodiments, the system memory 169 may include multiple different types of memory, as opposed to a single type of memory. In other embodiments, the system memory 169 may be a non-transitory data storage medium.

The peripheral storage unit 171, in various embodiments, may include support for magnetic, optical, magneto-optical, or solid-state storage media such as hard drives, optical disks (such as Compact Disks (CDs) or Digital Versatile Disks (DVDs)), non-volatile Random Access Memory (RAM) devices, etc. In some embodiments, the peripheral storage unit 171 may include more complex storage devices/systems such as disk arrays (which may be in a suitable RAID (Redundant Array of Independent Disks) configuration) or Storage Area Networks (SANs), which may be coupled to the processor 167 via a standard Small Computer System Interface (SCSI), a Fibre Channel interface, a Firewire® (IEEE 1394) interface, or another suitable interface. Various such storage devices may be non-transitory data storage media.

The display unit 172 may be a graphics/display device, a computer screen, an alarm system, a CAD/CAM (Computer Aided Design/Computer Aided Machining) system, a video game station, or any other type of data output device.

In one embodiment, the network interface 174 may communicate with the processor 167 to enable the system 165 to couple to a network (not shown). In another embodiment, the network interface 174 may be absent altogether. The network interface 174 may include any suitable devices, media and/or protocol content for connecting the system 165 to a network—whether wired or wireless. In various embodiments, the network may include Local Area Networks (LANs), Wide Area Networks (WANs), wired or wireless Ethernet, telecommunication networks, or other suitable types of networks.

The system 165 may include an on-board power supply unit 175 to provide electrical power to various system components illustrated in FIG. 12. The power supply unit 175 may receive batteries or may be connectable to an AC electrical power outlet. In one embodiment, the power supply unit 175 may convert solar energy into electrical power.

In one embodiment, the DVS 50 may be integrated with a high-speed interface such as, for example, a Universal Serial Bus 2.0 or 3.0 (USB 2.0 or 3.0) interface or above, that plugs into any Personal Computer (PC) or laptop. A non-transitory, computer-readable data storage medium, such as, for example, the system memory 169 or a peripheral data storage unit such as a CD/DVD may store program code or software. The processor 167 may be configured to execute the program code, whereby the processor 167 may be operative to receive and process pixel event signals from the DVS 50, detect the motion in a scene being sensed by the DVS 50, and display the detected motion through the display unit 172. The program code or software may be proprietary software or open source software which, upon execution by the processor 167, may enable the processor 167 to capture pixel events using their precise timing, process them, render them in a variety of formats, and replay them. As noted earlier, in certain embodiments, the digital control module 54 in the DVS 50 may perform some of the processing of pixel event signals before the pixel output data are sent to the processor 167 for further processing and motion detection/display. In other embodiments, the processor 167 may also perform the functionality of the digital control module 54, in which case, the digital control module 54 may not be a part of the DVS 50.

In the preceding description, for purposes of explanation and not limitation, specific details are set forth (such as particular architectures, techniques, etc.) in order to provide a thorough understanding of the disclosed technology. However, it will be apparent to those skilled in the art that the disclosed technology may be practiced in other embodiments that depart from these specific details. That is, those skilled in the art will be able to devise various arrangements which, although not explicitly described or shown herein, embody the principles of the disclosed technology. In some instances, detailed descriptions of well-known devices, circuits, and methods are omitted so as not to obscure the description of the disclosed technology with unnecessary detail. All statements herein reciting principles, aspects, and embodiments of the disclosed technology, as well as specific examples thereof, are intended to encompass both structural and functional equivalents thereof. Additionally, it is intended that such equivalents include both currently known equivalents as well as equivalents developed in the future, e.g., any elements developed that perform the same function, regardless of structure.

Thus, for example, it will be appreciated by those skilled in the art that block diagrams herein (e.g., in FIGS. 3-4) can represent conceptual views of illustrative circuitry or other functional units embodying the principles of the technology. Similarly, it will be appreciated that the flow chart in FIG. 9 represents various processes which may be substantially performed by a processor (e.g., the processor 167 in FIG. 12). The processor may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Some or all of the functionalities described above in the context of FIGS. 3-11 may be provided by the processor, in the hardware and/or software.

When certain inventive aspects require software-based processing, such software or program code may reside in a computer-readable data storage medium. As noted earlier, such data storage medium may be part of the peripheral storage 171 or may be part of the system memory 169 or the processor's 167 internal memory (not shown). The processor 167 may execute instructions stored on such a medium to carry out the software-based processing. The computer-readable data storage medium may be a non-transitory data storage medium containing a computer program, software, firmware, or microcode for execution by a general purpose computer or a processor mentioned above. Examples of computer-readable storage media include a ROM, a RAM, a digital register, a cache memory, semiconductor memory devices, magnetic media such as internal hard disks, magnetic tapes and removable disks, magneto-optical media, and optical media such as CD-ROM disks and DVDs.

Alternative embodiments of a DVS with shared pixels and TDM-based sampling of pixels according to inventive aspects of the present disclosure may include additional components responsible for providing additional functionality, including any of the functionality identified above and/or any functionality necessary to support the solution as per the teachings of the present disclosure. Although features and elements are described above in particular combinations, each feature or element can be used alone without the other features and elements or in various combinations with or without other features. As mentioned before, various functions discussed herein may be provided through the use of hardware (such as circuit hardware) and/or hardware capable of executing software/firmware in the form of coded instructions or microcode stored on a computer-readable data storage medium (mentioned above). Thus, such functions and illustrated functional blocks are to be understood as being either hardware-implemented and/or computer-implemented, and thus machine-implemented.

The foregoing describes a DVS where pixel pitch is reduced to increase spatial resolution. The DVS includes shared pixels that employ TDM for higher spatial resolution and better linear separation of pixel data. The pixel array in the DVS may consist of multiple N×N pixel clusters. The N×N pixels in each cluster share the same differentiator and the same comparator using TDM. The pixel pitch is reduced (and, hence, the total number of pixels or spatial resolution is improved) by implementing multiple adjacent photodiodes/photoreceptors that share the same differentiator and comparator units in a time division multiplexed fashion. In the DVS, only one quarter of the whole pixel array may be in use at the same time. A global reset may be done periodically to switch from one quarter of pixels to the other for detection. Because of higher spatial resolution, applications such as gesture recognition or user recognition based on DVS output entail improved performance.

As will be recognized by those skilled in the art, the innovative concepts described in the present application can be modified and varied over a wide range of applications. Accordingly, the scope of patented subject matter should not be limited to any of the specific exemplary teachings discussed above, but is instead defined by the following claims.

1. A vision sensor comprising:
a plurality of N×N pixel clusters, wherein each pixel cluster includes the following:
N×N photoreceptors, wherein each photoreceptor converts received luminance into a corresponding electrical signal,
a cluster-specific differentiator unit coupled to and shared by all of the N×N photoreceptors, wherein, for each photoreceptor in the N×N photoreceptors, the differentiator unit receives the corresponding electrical signal from the photoreceptor and generates a photoreceptor-specific difference signal indicative of the deviation of the corresponding electrical signal from a differentiator unit-specific reset level, and
a cluster-specific comparator unit coupled to the differentiator unit and shared by all of the N×N photoreceptors, wherein, for each photoreceptor in the N×N photoreceptors, the comparator unit receives the photoreceptor-specific difference signal and generates a corresponding pixel event signal indicative of a change in contrast of the received luminance; and
a digital control module coupled to the plurality of N×N pixel clusters for sequentiation and read-out of pixel event signals from each cluster-specific comparator unit.

2. The vision sensor of claim 1, wherein N=2.

3. The vision sensor of claim 1, wherein, for each pixel cluster, the cluster-specific differentiator unit and the cluster-specific comparator unit are shared by each photoreceptor in the N×N photoreceptors using time division multiplexing.

4. The vision sensor of claim 3, wherein, for each pixel cluster, the digital control module is configured to sequentially connect the cluster-specific differentiator unit to a different one of the N×N photoreceptors to receive the corresponding electrical signal from each photoreceptor in the pixel cluster, and wherein the sequential connection is based on a fixed order of selection or a pseudo-random order of selection.

5. The vision sensor of claim 4, wherein the digital control module is configured to sequentially connect the cluster-specific differentiator unit to a different one of the N×N photoreceptors in a periodic manner.

6. The vision sensor of claim 1, wherein the digital control module is configured to reset the cluster-specific differentiator unit either periodically at a pre-determined time interval or whenever the cluster-specific comparator unit communicates a pixel event signal to the digital control module.

7. The vision sensor of claim 1, wherein the digital control module is configured to select only one pixel at a time from each pixel cluster, thereby using only a quarter of all pixels in the vision sensor at a time during read-out of pixel event signals.

8. The vision sensor of claim 1, wherein the vision sensor is a Dynamic Vision Sensor (DVS).

9. The vision sensor of claim 1, wherein the digital control module includes a plurality of Address Event Representation (AER) logic units, wherein each AER logic unit is coupled to a corresponding one of the plurality of N×N pixel clusters.

10. The vision sensor of claim 1, wherein the pixel event signal is one of the following:
an ON event signal representing an increase in the received luminance over a first comparator threshold; and
an OFF event signal representing a decrease in the received luminance over a second comparator threshold.

11. An N×N pixel cluster comprising:
N×N photoreceptors, wherein each photoreceptor is configured to convert received luminance into a corresponding electrical signal;
a single differentiator unit configured to be coupled to and shared by all of the N×N photoreceptors, wherein, for each photoreceptor in the N×N photoreceptors, the differentiator unit is configured to receive the corresponding electrical signal from the photoreceptor and generate a photoreceptor-specific difference signal indicative of the deviation of the corresponding electrical signal from a differentiator unit-specific reset level; and
a single comparator unit coupled to the differentiator unit and configured to be shared by all of the N×N photoreceptors, wherein, for each photoreceptor in the N×N photoreceptors, the comparator unit is configured to receive the photoreceptor-specific difference signal and generate a corresponding pixel event signal indicative of a change in contrast of the received luminance.

12. The N×N pixel cluster of claim 11, wherein N=2.

13. The N×N pixel cluster of claim 11, wherein the single differentiator unit is configured to be sequentially connected to a different one of the N×N photoreceptors to receive the corresponding electrical signal from each photoreceptor in the N×N photoreceptors.

14. The N×N pixel cluster of claim 13, wherein the single differentiator unit is configured to be reset prior to each sequential connection to a different one of the N×N photoreceptors.

15. A system comprising:
a Dynamic Vision Sensor (DVS) that includes:
a plurality of 2×2 pixel clusters, wherein each pixel cluster includes:
2×2 photoreceptors, wherein each photoreceptor converts received luminance into a corresponding electrical signal,
a cluster-specific differentiator unit coupled to and shared by all of the 2×2 photoreceptors, wherein, for each photoreceptor in the 2×2 photoreceptors, the differentiator unit receives the corresponding electrical signal from the photoreceptor and generates a photoreceptor-specific difference signal indicative of the deviation of the corresponding electrical signal from a differentiator unit-specific reset level, and
a cluster-specific comparator unit coupled to the differentiator unit and shared by all of the 2×2 photoreceptors, wherein, for each photoreceptor in the 2×2 photoreceptors, the comparator unit receives the photoreceptor-specific difference signal and generates a corresponding pixel event signal indicative of a change in contrast of the received luminance;
a memory for storing program instructions; and
a processor coupled to the memory and the DVS, wherein the processor is configured to execute the program instructions, whereby the processor is operative to receive and process pixel event signals from each cluster-specific comparator unit.

16. The system of claim 15, wherein the DVS further includes a digital control module coupled to the plurality of 2×2 pixel clusters, wherein the digital control module is configured to read-out pixel event signals from each cluster-specific comparator unit and send the pixel event signals to the processor.

17. The system of claim 16, wherein, for each pixel cluster, the digital control module sequentially connects the cluster-specific differentiator unit to a different one of the N×N photoreceptors in a time division multiplexed manner to receive the corresponding electrical signal from each photoreceptor in the pixel cluster.

18. The system of claim 15, further comprising a display unit coupled to the processor to display a moving image output by the processor based on the processing of the pixel event signals.

19. (canceled)

20. (canceled)
